(19) United States
(12) Patent Application Publication
(10) Pub. No.: US 2023/0166579 A1
(43) Pub. Date: Jun. 1, 2023

(54) AIR-CONDITIONING CONTROL APPARATUS, VEHICLE, AND AIRCONDITIONING CONTROL METHOD

(71) Applicant: TOYOTA JIDOSHA KABUSHIKI KAISHA, Toyota-shi (JP)

(72) Inventor: Katsuya OISHI, Toyota-shi (JP)

(21) Appl. No.: 18/047,319

(22) Filed: Oct. 18, 2022

(30) Foreign Application Priority Data
Nov. 26, 2021 (JP) 2021-192095

(51) Int. Cl. B60H 1/00

(52) U.S. Cl. CPC B60H 1/00878; B60H 1/00271; B60H 2001/003

(57) ABSTRACT

An air-conditioning control apparatus includes an electronic control unit. The electronic control unit is configured to acquire temperature information of an electronic instrument provided in a vehicle cabin. The electronic control unit is configured to control air conditioning in the vehicle cabin based on the acquired temperature information of the electronic instrument.

### CROSS-REFERENCE TO RELATED APPLICATION

This application claims priority to Japanese Patent Application No. 2021-192095 filed on Nov. 26, 2021, incorporated herein by reference in its entirety.

### BACKGROUND

### 1. Technical Field

The disclosure relates to an air-conditioning control apparatus, a vehicle, and an air-conditioning control method.

### 2. Description of Related Art

Japanese Unexamined Patent Application Publication No. 2021-115951 (JP 2021-115951 A) describes a vehicle that uses heat generated from an electronic instrument. The vehicle includes an electronic instrument, a heat exchanger, and a cooling pipe. The heat exchanger exchanges heat between outside air and refrigerant. The cooling pipe makes up a flow channel that circulates refrigerant between the electronic instrument and the heat exchanger. Part of the cooling pipe extending from the electronic instrument toward the heat exchanger is disposed in a vehicle cabin. Refrigerant flowing through the cooling pipe circulates between the electronic instrument and the heat exchanger to cool the electronic instrument. Refrigerant that has drawn heat from the electronic instrument releases heat into the vehicle cabin while flowing through the cooling pipe disposed in the vehicle cabin.

### SUMMARY

The vehicle described in JP 2021-115951 A is capable of increasing the temperature in the vehicle cabin by using waste heat from the electronic instrument; however, there is room for improvement from the viewpoint of efficiently managing heat generated from the vehicle as a whole.

An aspect of the disclosure provides an air-conditioning control apparatus. The air-conditioning control apparatus includes an electronic control unit. The electronic control unit is configured to acquire temperature information of an electronic instrument provided in a vehicle cabin. The electronic control unit is configured to control air conditioning in the vehicle cabin based on the acquired temperature information of the electronic instrument.

With the air-conditioning control apparatus, air conditioning in the vehicle cabin is controlled based on the temperature information of the electronic instrument provided in the vehicle cabin. With this configuration, the air-conditioning control apparatus is able to, for example, turn down air conditioning for heating when heat generated from the electronic instrument is able to be used or turn up air conditioning for cooling in consideration of heat generated from the electronic instrument. Thus, the air-conditioning control apparatus is able to efficiently manage heat generated from the vehicle as a whole in comparison with the case where air conditioning is performed without using temperature information of the electronic instrument.

In one embodiment, the electronic control unit may be configured to store a location of the electronic instrument. The electronic control unit may be configured to control air conditioning at the location of the electronic instrument based on the stored location of the electronic instrument. In this case, the air-conditioning control apparatus is able to control air conditioning at each location of the electronic instrument disposed in the vehicle cabin.

In one embodiment, the electronic control unit may be configured to regulate a temperature in the vehicle cabin by using air flow from an air conditioner. In this case, the air-conditioning control apparatus is able to regulate the temperature in the vehicle cabin by changing air flow.

In one embodiment, the electronic control unit may be configured to acquire a temperature or an ambient temperature of the electronic instrument based on the temperature information of the electronic instrument, and the electronic control unit may be configured to, when the temperature or the ambient temperature of the electronic instrument is higher than or equal to a predetermined first temperature, operate the air conditioner such that the air conditioner produces air flow with a temperature lower than the predetermined first temperature to the electronic instrument. In this case, the air-conditioning control apparatus is able to use air conditioning for cooling the electronic instrument.

In one embodiment, the electronic control unit may be configured to acquire a temperature or an ambient temperature of the electronic instrument based on the temperature information of the electronic instrument, and may be configured to, when the temperature or the ambient temperature of the electronic instrument is higher than or equal to a predetermined second temperature, restrict air flow to the electronic instrument, produced by the air conditioner. In this case, the air-conditioning control apparatus is able to control air conditioning such that a temperature in a space in which the electronic instrument is disposed is regulated by using heat generation from the electronic instrument.

In one embodiment, the electronic control unit may be configured to acquire a temperature or an ambient temperature of the electronic instrument based on the temperature information of the electronic instrument, when the air conditioner produces cool air flow and the temperature or the ambient temperature of the electronic instrument is higher than or equal to a predetermined first temperature, operate the air conditioner such that the air conditioner produces air flow with a temperature lower than the predetermined first temperature to the electronic instrument, and, when the air conditioner produces warm air flow and the temperature or the ambient temperature of the electronic instrument is higher than or equal to a predetermined second temperature, restrict air flow to the electronic instrument, produced by the air conditioner. In this case, the air-conditioning control apparatus is able to efficiently manage heat generated by the vehicle as a whole based on the setting of the air conditioner and the temperature information of the electronic instrument.

Another aspect of the disclosure relates to a vehicle. The vehicle includes an air conditioner, an electronic instrument, a sensor, and an electronic control unit. The air conditioner is configured to regulate a temperature in a vehicle cabin. The electronic instrument is provided in the vehicle cabin. The sensor is configured to detect temperature information of the electronic instrument. The electronic control unit is configured to acquire the temperature information of the electronic instrument, detected by the sensor. The electronic control unit is configured to control the air conditioner based on the acquired temperature information of the electronic instrument. The vehicle has the same advantageous effects to those of the above-described air-conditioning control apparatus.

Further another aspect of the disclosure relates to an air-conditioning control method executed by an electronic control unit. The air-conditioning control method includes acquiring temperature information of an electronic instrument provided in a vehicle cabin, and controlling air conditioning in the vehicle cabin based on the acquired temperature information of the electronic instrument. The air-conditioning control method has the same advantageous effects to those of the above-described air-conditioning control apparatus.

Yet another aspect of the disclosure relates to a non-transitory storage medium storing instructions executable on a computer including one or more processors and causing the one or more processors to perform functions. The functions include acquiring temperature information of an electronic instrument provided in a vehicle cabin, and controlling air conditioning in the vehicle cabin based on the acquired temperature information of the electronic instrument. The non-transitory storage medium has the same advantageous effects to those of the above-described air-conditioning control apparatus.

According to the aspects of the disclosure, a technology for efficiently managing heat generated from a vehicle as a whole.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a vehicle according to an embodiment;

FIG. 2A is a plan view illustrating an example of air conditioners and air-conditioning ranges;

FIG. 2B is a side view of FIG. 2A;

FIG. 3A is a plan view illustrating an example of an electronic instrument;

FIG. 3B is a side view of FIG. 3A;

FIG. 4A is a side view illustrating an example of air conditioning with warm air;

FIG. 4B is a side view illustrating an example of air conditioning with cool air;

FIG. 5 is a flowchart showing the operations of an air-conditioning control apparatus;

FIG. 6A is a graph illustrating cooperative control over air conditioning with warm air; and

FIG. 6B is a graph illustrating cooperative control over air conditioning with cool air.

### DETAILED DESCRIPTION OF EMBODIMENTS

Hereinafter, an embodiment of the disclosure will be described with reference to the accompanying drawings.

### Configuration of Vehicle

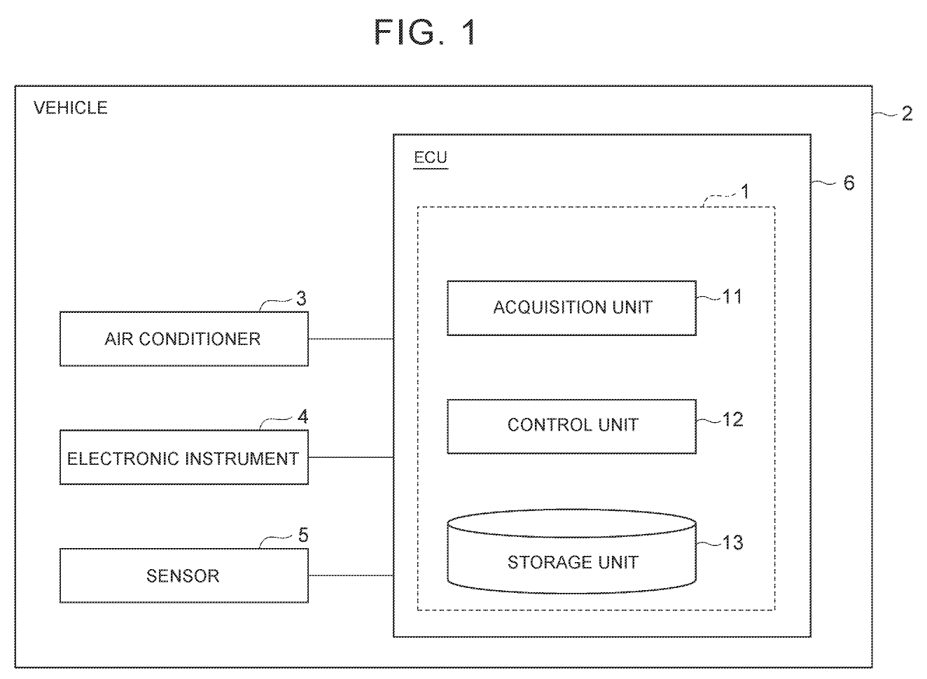

FIG. 1 is a block diagram of a vehicle according to the embodiment. As shown in FIG. 1, an air-conditioning control apparatus 1 is, for example, mounted on a vehicle 2 and controls air conditioning in a vehicle cabin. The vehicle 2 includes an air conditioner 3, an electronic instrument 4, a sensor 5, and an electronic control unit (ECU) 6. The air conditioner 3 and the sensor 5 are connected to the ECU 6 via communication.

The air conditioner 3 is a device that regulates the temperature in the vehicle cabin of the vehicle 2. The air conditioner 3 includes a heat exchanger and has both heating and cooling functions. When the air conditioner 3 is set to a heating mode to use the heating function, the air conditioner 3 produces air flow (warm air flow) adjusted to a set temperature. When the air conditioner 3 is set to a cooling mode to use the cooling function, the air conditioner 3 produces air flow (cool air flow) adjusted to a set temperature. The air conditioner 3 may be configured to be able to regulate not only the temperature and rate of air flow but also the direction of air flow. In other words, the air conditioner 3 may be configured to be able to regulate the temperature in the vehicle cabin by producing air flow. The air conditioner 3 is configured to use the heating function or the cooling function based on a signal output from the ECU 6. As a more specific example, the air conditioner 3 is configured to regulate the temperature, rate, direction, and the like of air flow based on a signal output from the ECU 6.

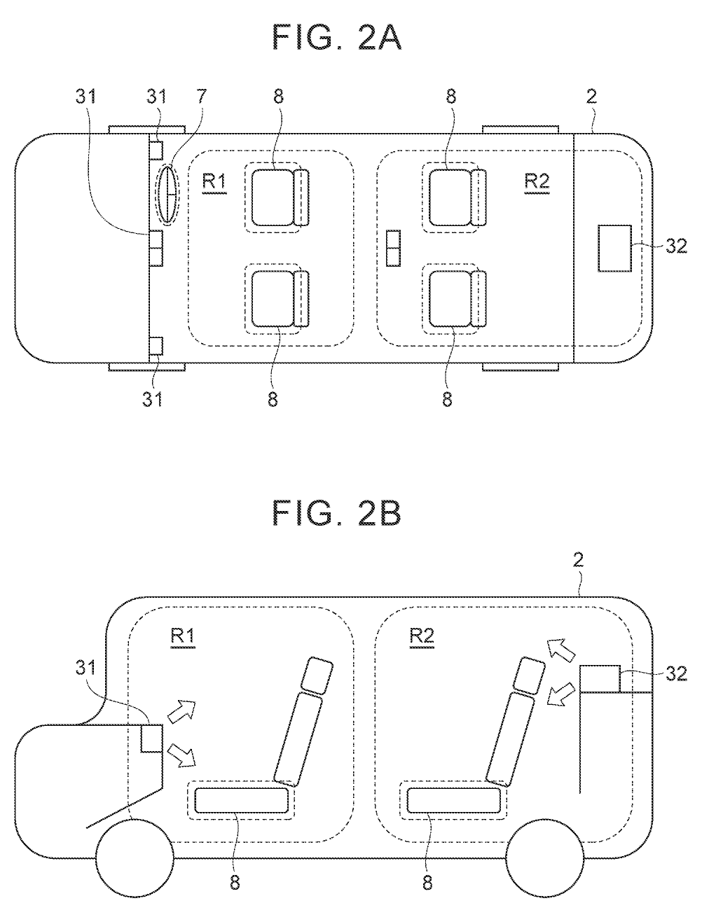

FIG. 2A is a plan view illustrating an example of air conditioners and air-conditioning ranges. FIG. 2B is a side view illustrating an example of the air conditioners and the air-conditioning ranges. As shown in FIG. 2A and FIG. 2B, the vehicle 2 includes a front seat air conditioner 31 and a rear seat air conditioner 32 as an example of the air conditioner 3. The front seat air conditioner 31 produces temperature-regulated air flow from an instrument panel. An air-conditioning range R1 of the front seat air conditioner 31 includes a vehicle cabin front space, a front seat below, and a front shield. The front seat air conditioner 31 is able to regulate not only the temperature and rate of air flow but also the direction of air flow. For example, the front seat air conditioner 31 is able to produce air flow toward any one of the vehicle cabin front space, the front seat below, and the front shield or a combination of any two or more of them. The rear seat air conditioner 32 is provided in the rear of the vehicle cabin and produces temperature-regulated air flow. An air-conditioning range R2 of the rear seat air conditioner 32 includes a vehicle cabin rear space and a rear seat below. The rear seat air conditioner 32 is able to regulate not only the temperature and rate of air flow but also the direction of air flow. For example, the rear seat air conditioner 32 is able to produce air flow toward any one of the vehicle cabin rear space and the rear seat below or both. The vehicle 2 may include a steering wheel heater 7 and seat heaters 8 (seat air conditioners) as other temperature regulating devices.

The electronic instrument 4 is a device provided in the vehicle cabin. The electronic instrument 4 can be disposed in, for example, a space under a seat. The electronic instrument 4 is a device that generates heat and includes, for example, an integrated circuit. The electronic instrument 4 may have a heat radiation structure so as to have a temperature lower than a predetermined upper limit temperature (an example of a first temperature) in order for the integrated circuit and the like to stably operate. The upper limit temperature is a preset threshold for determining whether the electronic instrument 4 stably operates. The upper limit temperature is set so as to be higher than a target temperature in the vehicle cabin and is, for example, higher than or equal to 70° C.

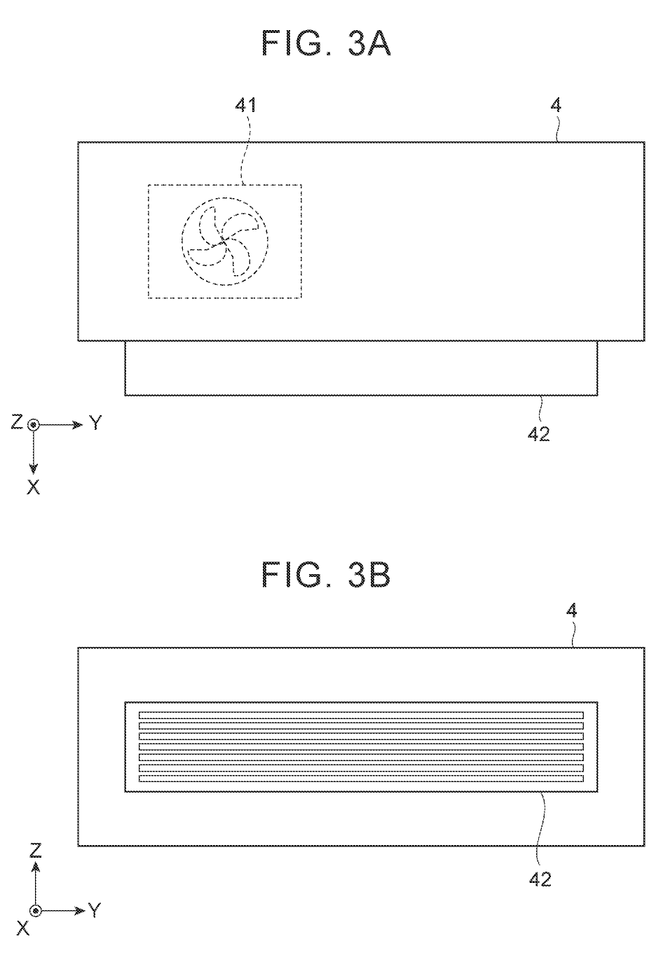

FIG. 3A is a plan view illustrating an example of the electronic instrument. FIG. 3B is a side view of FIG. 3A. The electronic instrument 4 shown in FIG. 3A and FIG. 3B includes the integrated circuit in a casing. The electronic instrument 4 includes a fan 41 and a heat radiation port 42 as the heat radiation structure. When the fan 41 rotates, flow of air is generated in the casing. Air in the casing is discharged from the heat radiation port 42 to outside the casing. In this way, the electronic instrument 4 releases generated heat to outside the casing. For this reason, the electronic instrument 4 can increase the temperature in the space around the electronic instrument 4. Examples of the electronic instrument 4 include a drive battery that stores electric energy, a power control unit that controls the output of the drive battery, and an ECU that executes various controls.

The sensor 5 is a detector that detects temperature information of the electronic instrument 4. The sensor 5, for example, detects the temperature or heat generation amount of the electronic instrument 4 as the temperature information. The sensor 5 may be mounted on, for example, the substrate of the integrated circuit of the electronic instrument 4 as a chip. The sensor 5 may be disposed in the casing of the electronic instrument 4. The sensor 5 may be disposed on the outer surface of the casing of the electronic instrument 4 or near the electronic instrument 4. In this case, the sensor 5 detects the ambient temperature of the electronic instrument 4 as the temperature information of the electronic instrument 4. The ambient temperature is the temperature of the space in which the electronic instrument 4 is disposed. The temperature information detected by the sensor 5 is output to the ECU 6.

The ECU 6 executes control related to the air conditioner 3. The ECU 6 is an electronic control unit that includes a central processing unit (CPU), a read only memory (ROM), a random access memory (RAM), a controller area network (CAN) communication circuit, and the like. The ECU 6 is connected to a network that communicates by using, for example, the CAN communication circuit, and is connected so as to be able to communicate with components of the vehicle 2. The ECU 6, for example, inputs and outputs data by operating the CAN communication circuit based on a signal output from the CPU, stores data in the RAM, and runs a program stored in the ROM. Thus, the ECU 6 implements control related to the air conditioner 3. The ECU 6 may implement control related to the air conditioner 3 by loading a program onto the RAM and running the program loaded on the RAM. The ECU 6 may be made up of a plurality of electronic control units.

The ECU 6 includes an acquisition unit 11, a control unit 12, and a storage unit 13. The acquisition unit 11, the control unit 12, and the storage unit 13 make up the air-conditioning control apparatus 1.

The acquisition unit 11 acquires the temperature information of the electronic instrument 4. The acquisition unit 11 acquires the temperature information of the electronic instrument 4 via communication. As an example, the acquisition unit 11 acquires the temperature information of the electronic instrument 4, detected by the sensor 5.

The control unit 12 controls air conditioning in the vehicle cabin based on the temperature information of the electronic instrument 4, acquired by the acquisition unit 11. As an example, the control unit 12 controls the air conditioner 3 based on the temperature information of the electronic instrument 4. The control unit 12 may turn down heating when the temperature of the electronic instrument 4 or the ambient temperature of the electronic instrument 4 is higher than a set temperature in the vehicle cabin. Turning down heating may be, for example, for the control unit 12 to reduce the air volume or to decrease the temperature of air flow below a set temperature.

The control unit 12 may change the direction of air flow based on the temperature information of the electronic instrument 4. In this case, the control unit 12 references the storage unit 13. The storage unit 13 stores the location of the electronic instrument 4. The storage unit 13 may store the identification number of the electronic instrument 4 and the location in association with each other. For example, when an ECU with the identification number “1” is disposed in the space under a driver seat, the storage unit 13 stores the identification number “1” and space coordinates under the driver seat in association with each other. For example, when an ECU with the identification number “2” is disposed in the space under a front passenger seat, the storage unit 13 stores the identification number “2” and space coordinates under the front passenger seat in association with each other.

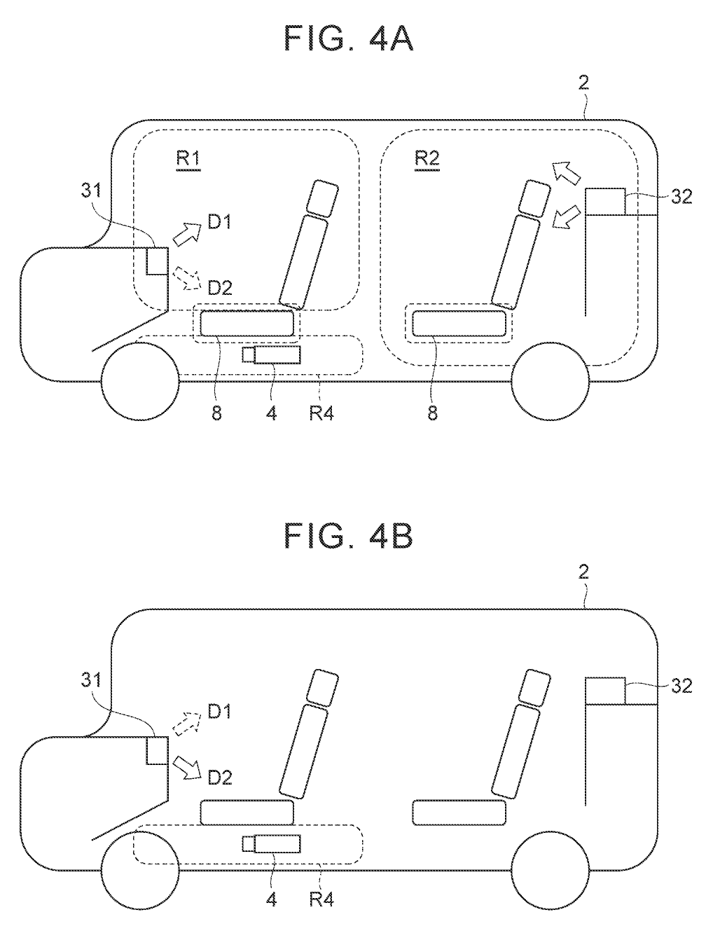

The control unit 12 controls air conditioning at the location of the electronic instrument 4 based on the location of the electronic instrument 4, stored in the storage unit 13. For example, when the temperature or the ambient temperature of the ECU with the identification number “2” is higher than or equal to a set temperature (an example of a second temperature) in the vehicle cabin, the control unit 12 restricts temperature-regulated air flow (warm air flow) to the ECU with the identification number “2”. Restricting air flow is to reduce the volume of air flow or to shift an object off from the direction of air flow such that the object is not hit by air flow. FIG. 4A is a side view illustrating an example of air conditioning with warm air. As shown in FIG. 4A, the electronic instrument 4 is disposed under the front passenger seat. The front seat air conditioner 31 is able to produce air flow in any one of a direction D1 toward the vehicle cabin front space and a direction D2 toward the front seat below. The control unit 12 sets the direction of air flow of the front seat air conditioner 31 to D1. Thus, it is possible to make the electronic instrument 4 that is hotter than the set temperature in the vehicle cabin be in charge of regulating the temperature of the space (air-conditioning range R4).

When the temperature or the ambient temperature of the ECU with the identification number “2” is higher than or equal to the upper limit temperature, the control unit 12 operates the air conditioner 3 such that the air conditioner 3 produces air flow (cool air flow), of which the temperature is regulated to a temperature lower than the upper limit temperature, to the ECU with the identification number “2”. FIG. 4B is a side view illustrating an example of air conditioning with cool air. As shown in FIG. 4B, the electronic instrument 4 is disposed under the front passenger seat. The front seat air conditioner 31 is able to produce air flow in any one of the direction D1 toward the vehicle cabin front space and the direction D2 toward the front seat below. The control unit 12 sets the direction of air flow of the front seat air conditioner 31 to D2. In this way, the air-conditioning control apparatus 1 is able to use the air conditioner 3 for cooling the electronic instrument 4.

### Air-Conditioning Control Method

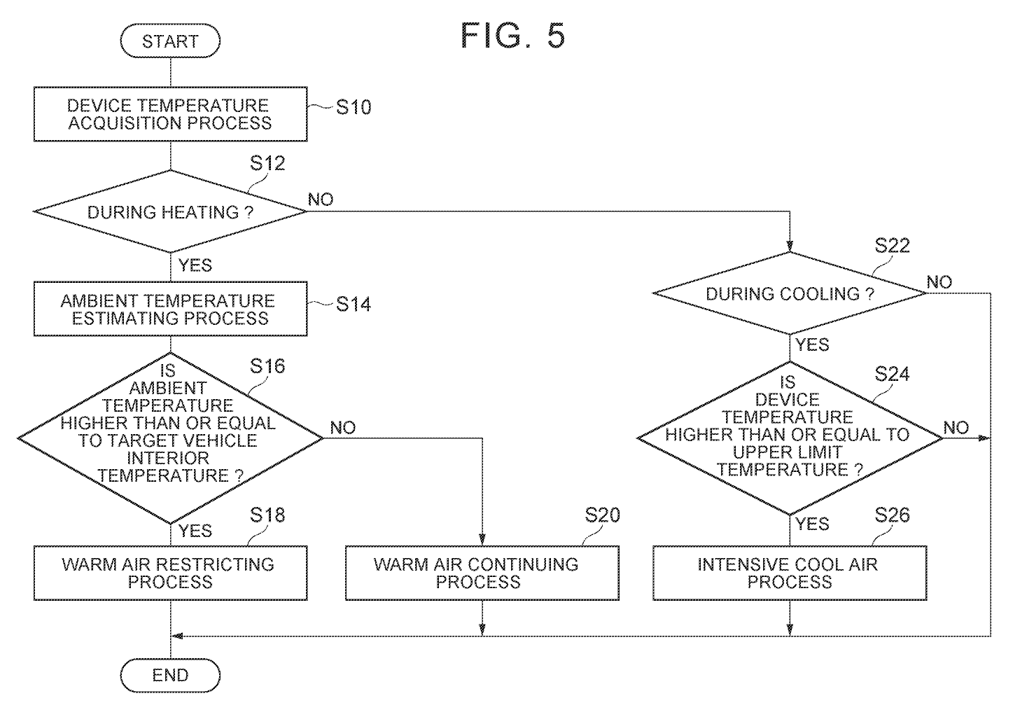

FIG. 5 is a flowchart showing the operations of the air-conditioning control apparatus. The flowchart shown in FIG. 5 is started based on, for example, an instruction from an occupant of the vehicle 2.

As shown in FIG. 5, initially, the air-conditioning control apparatus 1 acquires the temperature of the electronic instrument 4 disposed in the vehicle cabin of the vehicle 2 as a device temperature acquisition process (step S10). As a specific example, the acquisition unit 11 of the air-conditioning control apparatus 1 acquires the temperature of the electronic instrument 4 from the sensor 5 provided for the electronic instrument 4.

Subsequently, the air-conditioning control apparatus 1 determines whether it is during heating as a determination process (step S12). When the air-conditioning control apparatus 1 is operating in the heating mode (when, for example, a heating button is turned on by an occupant), the air-conditioning control apparatus 1 determines that it is during heating.

When the air-conditioning control apparatus 1 determines that it is during heating (YES in step S12), the air-conditioning control apparatus 1 estimates the ambient temperature as an ambient temperature estimating process (step S14). The air-conditioning control apparatus 1 estimates the ambient temperature of the electronic instrument 4 from the temperature of the electronic instrument 4. For example, the air-conditioning control apparatus 1 previously stores the temperature of the electronic instrument 4 and the ambient temperature of the electronic instrument 4 in association with each other. The air-conditioning control apparatus 1 is able to estimate the ambient temperature of the electronic instrument 4 based on the measured temperature of the electronic instrument 4 and the stored relationship.

Subsequently, the air-conditioning control apparatus 1 determines whether the estimated ambient temperature is higher than or equal to the target vehicle interior temperature as a determination process (step S16). When the air-conditioning control apparatus 1 determines that the ambient temperature is higher than or equal to the target vehicle interior temperature (YES in step S16), the air-conditioning control apparatus 1 restricts warm air flow to the electronic instrument 4 (see FIG. 4A) as a warm air restricting process (step S18). When the air-conditioning control apparatus 1 determines that the ambient temperature is not higher than or equal to the target vehicle interior temperature (NO in step S16), the air-conditioning control apparatus 1 continues to produce warm air flow to the electronic instrument 4 (see FIG. 4A) as a warm air continuing process (step S20).

When the air-conditioning control apparatus 1 determines that it is not during heating (NO in step S12), the air-conditioning control apparatus 1 determines whether it is during cooling as a determination process (step S22). When the air-conditioning control apparatus 1 is operating in the cooling mode (when, for example, a cooling button is turned on by the occupant), the air-conditioning control apparatus 1 determines that it is during cooling.

When the air-conditioning control apparatus 1 determines that it is during cooling (YES in step S22), the air-conditioning control apparatus 1 determines whether the temperature of the electronic instrument 4 is higher than or equal to the upper limit temperature as a determination process (step S24). When the air-conditioning control apparatus 1 determines that the temperature of the electronic instrument 4 is higher than or equal to the upper limit temperature (YES in step S24), the air-conditioning control apparatus 1 produces cool air flow intensively to the electronic instrument 4 (see FIG. 4B) as an intensive cool air process (step S26).

When the air-conditioning control apparatus 1 determines that it is not during cooling (NO in step S22), when the warm air restricting process (step S18), the warm air continuing process (step S20), and the intensive cool air process (step S26) complete, or when the air-conditioning control apparatus 1 determines that the temperature of the electronic instrument 4 is not higher than or equal to the upper limit temperature (NO in step S24), the flowchart shown in FIG. 5 ends. After the process ends, the air-conditioning control apparatus 1 starts the flowchart shown in FIG. 5 from the beginning until an occupant’s operation end instruction is issued.

### Cooperative Control

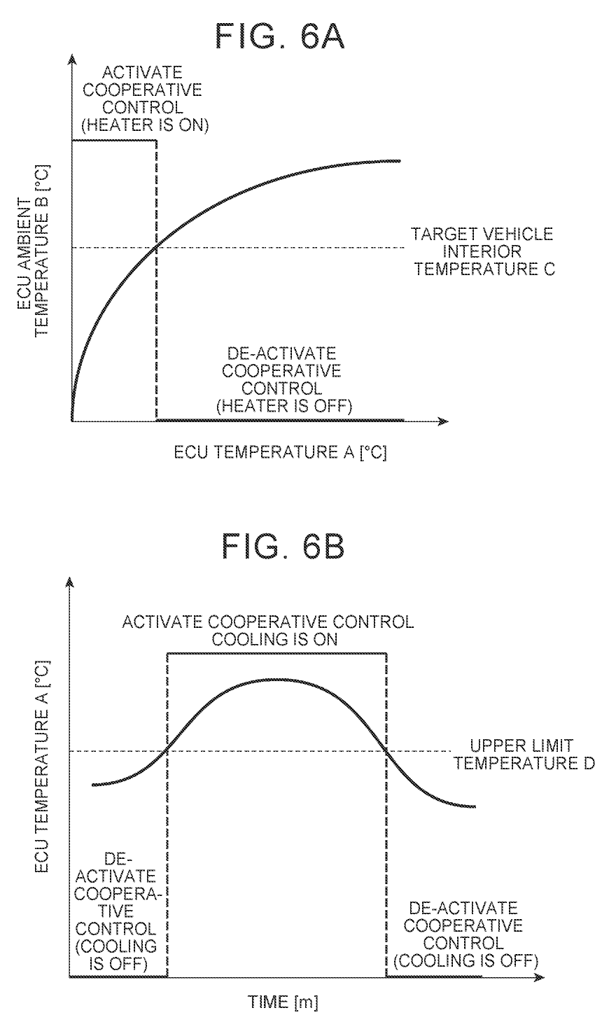

By executing the flowchart shown in FIG. 5, it is possible to cooperate air conditioning using the air conditioner 3 with air conditioning using heat generated from the electronic instrument 4. FIG. 6A is a graph illustrating cooperative control over air conditioning with warm air. In FIG. 6A, the abscissa axis represents ECU temperature A, and the ordinate axis represents ECU ambient temperature B. As shown in FIG. 6A, when the relationship between the ECU ambient temperature B and the target vehicle interior temperature C is B < C, cooperative control is activated, and both air conditioning using the air conditioner 3 and air conditioning using heat generated from the electronic instrument 4 are performed. When the relationship between ECU ambient temperature B and target vehicle interior temperature C is B >= C, cooperative control is de-activated, air conditioning using the air conditioner 3 ends, and only air conditioning using heat generated from the electronic instrument 4 is performed.

FIG. 6B is a graph illustrating cooperative control over air conditioning with cool air. In FIG. 6B, the abscissa axis represents time, and the ordinate axis represents ECU temperature A. As shown in FIG. 6B, when the relationship between ECU temperature A and upper limit temperature D is A < D, cooperative control is de-activated, and an operation to decrease the temperature of the electronic instrument 4 is not performed by the air conditioner 3. When the relationship between ECU temperature A and upper limit temperature D is A >= D, cooperative control is activated, and the air conditioner 3 produces cool air flow to the electronic instrument 4.

### Summary of Embodiment

With the air-conditioning control apparatus 1, air conditioning in the vehicle cabin is controlled based on the temperature information of the electronic instrument 4 provided in the vehicle cabin. With this configuration, the air-conditioning control apparatus 1 is able to turn down air conditioning for heating when heat generated from the electronic instrument 4 is able to be used or turn up air conditioning for cooling in consideration of heat generated from the electronic instrument 4. Thus, the air-conditioning control apparatus 1 is able to efficiently manage heat generated from the vehicle as a whole in comparison with the case where air conditioning is performed without using the temperature information of the electronic instrument 4.

The example embodiment has been described above; however, the disclosure is not limited to the example embodiment, and various omissions, replacements, and changes are possible. For example, the air conditioner 3 may include the seat heaters 8. The functions of the air-conditioning control apparatus 1 may be provided by a program. For example, the program causes a computer to exercise the same functions as those of the acquisition unit 11 and the control unit 12. The program can be stored in a storage medium.

What is claimed is:

1. An air-conditioning control apparatus comprising an electronic control unit configured to
acquire temperature information of an electronic instrument provided in a vehicle cabin, and
control air conditioning in the vehicle cabin based on the acquired temperature information of the electronic instrument.

2. The air-conditioning control apparatus according to claim 1, wherein the electronic control unit is configured to
store a location of the electronic instrument, and
control air conditioning at the location of the electronic instrument based on the stored location of the electronic instrument.

3. The air-conditioning control apparatus according to claim 1, wherein the electronic control unit is configured to regulate a temperature in the vehicle cabin by using air flow from an air conditioner.

4. The air-conditioning control apparatus according to claim 3, wherein the electronic control unit is configured to
acquire a temperature or an ambient temperature of the electronic instrument based on the temperature information of the electronic instrument, and
when the temperature or the ambient temperature of the electronic instrument is higher than or equal to a predetermined first temperature, operate the air conditioner such that the air conditioner produces air flow with a temperature lower than the predetermined first temperature to the electronic instrument.

5. The air-conditioning control apparatus according to claim 3, wherein the electronic control unit is configured to
acquire a temperature or an ambient temperature of the electronic instrument based on the temperature information of the electronic instrument, and
when the temperature or the ambient temperature of the electronic instrument is higher than or equal to a predetermined second temperature, restrict air flow to the electronic instrument, produced by the air conditioner.

6. The air-conditioning control apparatus according to claim 3, wherein the electronic control unit is configured to
acquire a temperature or an ambient temperature of the electronic instrument based on the temperature information of the electronic instrument,
when the air conditioner produces cool air flow and the temperature or the ambient temperature of the electronic instrument is higher than or equal to a predetermined first temperature, operate the air conditioner such that the air conditioner produces air flow with a temperature lower than the predetermined first temperature to the electronic instrument, and
when the air conditioner produces warm air flow and the temperature or the ambient temperature of the electronic instrument is higher than or equal to a predetermined second temperature, restrict air flow to the electronic instrument, produced by the air conditioner.

7. A vehicle comprising:
an air conditioner configured to regulate a temperature in a vehicle cabin;
an electronic instrument provided in the vehicle cabin;
a sensor configured to detect temperature information of the electronic instrument; and
an electronic control unit configured to
acquire the temperature information of the electronic instrument, detected by the sensor, and
control the air conditioner based on the acquired temperature information of the electronic instrument.

8. An air-conditioning control method executed by an electronic control unit, the air-conditioning control method comprising:
acquiring temperature information of an electronic instrument provided in a vehicle cabin; and
controlling air conditioning in the vehicle cabin based on the acquired temperature information of the electronic instrument.
